(19) United States
(12) Patent Application Publication
(10) Pub. No.: US 2019/0213632 A1
(43) Pub. Date: Jul. 11, 2019

(54) Digital Advertisement In Live Events

(71) Applicant: GRAMSOFT LTD., Tel Aviv (IL)

(72) Inventors: Gabriel Amram, Tel Aviv (IL); Maayan Levy, Bet Yitzhak-Sha'ar Khefer (IL); Raviv Ventura, Hod-Hasharon (IL)

(21) Appl. No.: 16/323,798

(22) PCT Filed: Jul. 30, 2017
(86) PCT No.: PCT/IB2017/054638

§ 371 Date: Feb. 7, 2019

Related U.S. Application Data
(60) Provisional application No. 62/371,856, filed on Aug. 8, 2016.

(51) Int. Cl. G06Q 30/02

(52) U.S. Cl. CPC G06Q 30/0252; G06Q 30/0249; G06Q 30/0275

(57) ABSTRACT

A system and for digital advertisement in live events, comprising: a plurality of advertisers' computers configured to create advertisement campaign offers; at least one event organizer's computer configured to define an event; a matching engine communicating bi-directionally with said plurality of advertisers' computers and with said at least one event organizer's computer, said matching engine configured to rank advertisements for said event and create a digital folder of advertisements accordingly; and a plurality of user electronic communication devices comprising a computer software configured to display said digital folder and enable interaction with said advertisements; said matching engine further comprising a campaign analytics module configured to affect said ranking according to the performance of said digital folder.

### FIELD OF THE INVENTION

The present invention is in the field of advertisement and more specifically advertisement in live events.

### BACKGROUND

The primary goal of every marketing program is to get to as focused a target audience as possible. A survey taken by the Nielsen Institute checked the degree to which the public trusts advertisements. It was found that there is a strong increase in the audience's trust of brand sponsorships over other advertising media such as emails, online video advertisements and search engine banners.

Advertising by sponsorship is common. The type and extent of exposure which the advertiser reaches using this method depends on the amount of money he invests, which is why there are different prices for different levels of advertisement.

Advertisers and brand manager constantly seek new channels for reaching their target audiences. Events provide an advertising channel in which people having specific fields of interest gather to exchange ideas, debate and be introduced to new products and services they could use.

Advertising in events matches the growing demand for advertising by sponsorship to well defined target audiences. The participants in an event register in advance leaving their contact details, they also spend money and time for attending the event, so that if the advertisement is relevant to them their level of engagement is expected to be high. Researches show that thousands of events in various fields take place every year. Only in Europe, for example, there were 2500 events in the year 2012.

Although today sponsors take part in many events for advertising, sales and brand empowerment, they are faced with a number of obstacles:
1. A great amount of time is spent in finding the right event and establishing the compatibility of the audience in order to maximize the advertising effectiveness. It is also necessary to quantify the relevancy and the probability of the event being effective for them, which is a complicated task which often results in unsatisfactory forecasts.
2. The sponsors have to negotiate with the event organizer for each event individually regarding the manner of exposure of the advertisers, their participation in the event and the space allocated for them in the event.
3. In many events the advertisers have to establish their presence in the event by way of a booth, sending sales people, sending speakers, preparing advertising materials etc. This has to be done for each event separately.
4. The advertisers have no way to measure the effectiveness of the advertising—it is hard to know how many people were exposed to the advertisement, how many have shown interest and how many of their future clients will have arrived as a consequence.
5. Advertisers often find themselves investing significant budgets in advertising that sometimes turns out to be ineffective, not engaging enough to the audience attending the event and not suitable for their marketing goals.

On the other hand, organizers of small to medium events and community meet-ups often find it difficult to find advertisers. For the organizer this source of income can be the difference between a one-time event and a recurring one. This income helps event organizers to support their community, the various officers and the resources required for organizing such events.

There is need for a system that will provide a comprehensive solution for the problem of maximizing the compatibility between event organizers and advertising sponsors.

### SUMMARY

According to an aspect of the invention there is provided a computerized system for digital advertisement in live events, comprising: a plurality of advertisers' computers configured to create advertisement campaign offers; at least one event organizer's computer configured to define an event; a matching engine communicating bi-directionally with said plurality of advertisers' computers and with said at least one event organizer's computer, said matching engine configured to rank advertisements for said event and create a digital folder of advertisements accordingly; and a plurality of user electronic communication devices comprising a computer software configured to display said digital folder and enable interaction with said advertisements; said matching engine further comprising a campaign analytics module configured to affect said ranking in real time according to the performance of said digital folder.

The matching engine may further comprise:
a pricing module configured to predict optimal bid-prices to be offered by said advertisers; and
a matching module configured to determine the extent to which an event's target audience matches the advertiser's campaign; and wherein said matching module is configured to rank said advertisements by combining the results of said matching module and the pricing module.

Each one of said advertisement campaign offers may comprise description of a product or service to be advertised, target audience and budget.

The event definition may comprise event name, place and date.

According to another aspect of the invention there is provided a method of digital advertisement in live events, comprising: creating a plurality of advertisement campaign offers, each advertisement campaign offer including a first target audience; defining at least one event; using online information for defining a second target audience for said at least one event; matching said first and second target audiences for each one of said plurality of advertisements; determining optimal bid-price for each one of said plurality of advertisements; using said matching and said determined bid-price to rank said plurality of advertisements for said at least one event; creating a digital folder for said at least one event, said digital folder comprising top ranking advertisement from said ranking process; and displaying said digital folder to participants of said at least one event.

The method may further comprise: receiving feedback of said participants' interactions with the advertisements in said digital folder; analyzing said feedback; and updating said ranking accordingly.

Each one of said advertisement campaign offers may comprise description of a product or service to be advertised, target audience and budget.

The event definition may comprise event name, place and date.

The matching may comprise: defining a weighted graph of fields of interest; and finding on said graph nodes corresponding to both said first and said second target audiences. The method may further comprise determining a third target audience according to said found nodes and the weights between them.

The digital folder may be personalized.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a block diagram showing the various components of an embodiment of the system; and

FIG. 2 is a flowchart showing the various steps taken by the method according to embodiments of the present invention.

### DETAILED DESCRIPTION OF SOME EMBODIMENTS

The present invention provides a platform that enables digital advertisement in live events, based on locating specific target audiences and personal matching of content to participants in an online “self service” mode and a performance based model. The new platform enables automatic location and analysis of target audiences in events, creation of dedicated campaigns and their deployment in relevant events.

The novel advertising platform of the present invention enables event organizers to find sponsors for their events and enables sponsors to find events in which their target audiences are and automatically, without the need to invest time, advertise their campaign and measure its performance.

The platform uses events in which the participants have common fields of interest, assuming that since these participants invest their time and money to attend the event, the event probably matches their field of interest and they will be interested in the right offers.

The advertiser does not have to look for events and to negotiate each event separately, since he predefines the budget. These definitions are valid as long as the campaign is running. The advertiser can also measure his success and pay accordingly.

The advertisers gain easy access to thousands of events each year, with mapping of their target audiences, to facilitate their decision regarding the extent of relevancy and the budget they are willing to offer.

The campaign is done via a digital portfolio, thus the advertiser does not have to invest in a physical campaign.

The advertiser receives an analysis of the campaign's performance and insights regarding the campaign.

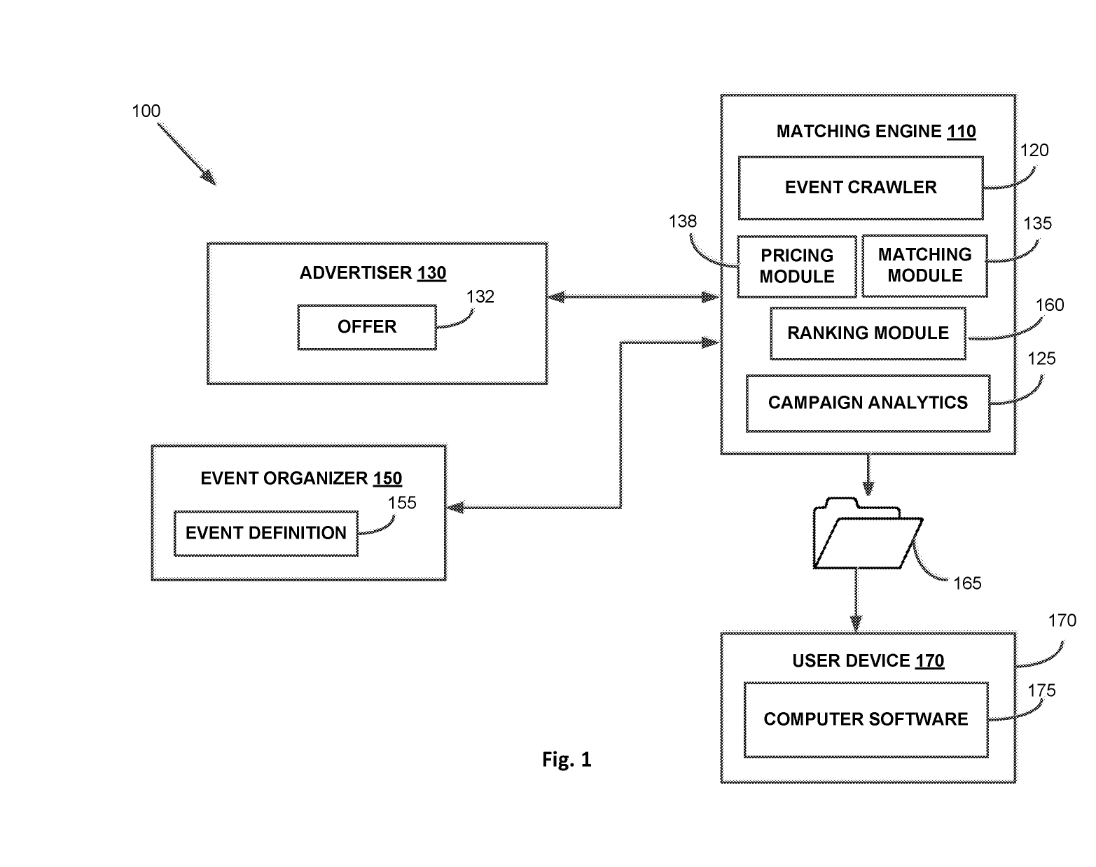

FIG. 1 is a block diagram showing the various components of an embodiment of the system 100.

System 100 according to this embodiment is a computerized system comprising a matching engine 110, a plurality of advertiser's computer 130 (only one shown), at least one events organizer computer 150 and a plurality of user electronic communication devices 170 (only one shown), such as smart phone, tablet, wearable device etc.

The advertiser computer 130 comprises:

An offer module 132 which communicates to the matching engine 110 details of an offer, comprising description of a product or service to be advertised, target audience and budget.

The matching engine 110 comprises:

An event crawler 120, which receives a few details regarding a planned event from the event organizer 150 (e.g. event name, place, date) and gathers online information regarding the event from various sources (e.g. open APIs and legal web scraping). Using Natural Language Processing (NLP) techniques, the event crawler analyzes the text and context of these events' publications in order to define the event's audience profile (e.g. fields of interest, demographic characteristics) and to understand the event's topic(s), the level of engagement to the event (e.g. number and sentiment of references to the event in social networks, blogs, network journals etc., the extent to which previous events have succeeded, how many people are planning to attend, what types of people have bought tickets).

The NLP algorithms used are based on machine learning and continuously “learn” new words they come across, “understand” the context in which they were used and whether they are relevant. For example, information related to an event in the field of mobile development may include description of the food to be served in the event. The algorithms deduces that the event is not about food, but rather about mobile development, based on additional information gathered about the event and the context in which words are used.

After the target audience for the event has been defined, the event organizer may approve or correct the definition, providing a learning basis for the system for future events.

A campaign analytics module 125 provides event organizers and advertisers full control over their objects (i.e. offer, conference's digital folder, number of participants who viewed the offer, number of participants who accepted the offer, etc).

According to embodiments of the invention, the analytics module 125 provides Business Intelligence (BI) related to the offer's performance as compared to other offers. For example, the advertiser's offer has been placed in the digital folder in the 4^{th} place; the offer in the 2^{nd} place is less relevant but has a higher pricing and has received many acceptances from participants. An interesting insight the analytics module may provide in this case is that had the advertiser invested more in his offer, his offer would have been ranked at a higher place in the digital folder and would have been more successful. In another example, if the algorithm has chosen a first advertiser's offer over a second advertiser's offer, the analytics module may provide the second advertiser insight such as changing the offer's type could have resulted in the algorithm and the event organizer preferring his offer. For example, had the advertiser offered “a chance of winning a lottery” instead of offering “a $100 coupon” his offer could have been more successful for the specific audience, since the algorithm has found that offers of this type have succeeded more as compared to offers of the first type, regardless of their matching.

Another example, if an offer has been publicized and succeeded in various events including audiences tangential to the predefined target audience, the advertiser may decide to broaden his target audience to include those tangential audiences and thus gain greater exposure in other events.

For the event organizer, the campaign analytics module 125 provides the ability to see the performance of deploying the digital folder—how many participants opened the digital folder, how many offers were viewed, how many offers were accepted/rejected etc. The event organizer is also able to drill down to the performance of each campaign in his event. The system may also provide the event organizer insights; for example, if he had placed a certain offer in a too low place, whether placing the offer in a higher place would have received more acceptances than another higher-priced offer, etc. This may help the event organizer to prepare better for future events.

The event organizer may receive information about percentages of the digital folder exposure (possibly by distribution channel) and analysis of the event's income.

A matching module 135 uses supervised machine learning for determining the extent to which an event's target audience matches the advertiser's campaign.

The matching module 135 determines the extent of relevancy of the campaign's target audience to the expected event's target audience. This determination requires analyses that encompass characteristics and connections between types of audiences, fields of interest, demographic slicing, professions etc.

This is enabled by a new dictionary of target audiences and fields of interest. The dictionary is translated into a weighted graph of target audiences and fields of interest, where the weights change according to context.

Each field of interest is represented by a node in the graph. A node may have different characteristics; one of the main characteristics is “synonyms”—for example “programmer” and “computer programmer” are considered synonyms and occupy one node in the graph.

Each node in the graph is connected with other nodes by weighted edges. An edge has a characteristic of the category to which it belongs. For example, an edge between the nodes “CTO” and “Software Developer” has a category “Software development” with a certain weight (e.g. 0.7) but an edge between the nodes “CTO” and “CEO” has a category “Management”, possibly with a different weight.

This graph representation enables to present, for a certain field of interest, all the categories to which it belongs, its connection to other fields of interest in each of the categories, its nearest neighbors (most similar fields of interest) and also fields of interest having the same category but farther away on the graph. For example, “Web development” and “Django development” are very close and have a direct connection. “Django development” has a strong connection with “Python development”, but “phyton” and “web” have a weaker indirect connection. “Python development” has a strong connection to “server-side scripting”, which has a very low connection to “web”, although all these examples belong to the category “Software development”. When an advertiser defines an offer he may define a number of “natural” target audiences and the matching algorithm, by traversing the graph according to the advertiser's initial definitions, may help him define tangential audiences, more specific audiences or broader audiences.

The two defined target audiences, i.e. the one defined by the advertiser and the second defined by the event crawler are categorized by the graph and then the system computes the overlap of the two resulting groups of categories and the extent to which they are close, to grade the matching between the two target audiences.

Moreover, each group of categories may be divided into clusters of sub-groups and a novel algorithm enables traversing the graph to find connections between sub-groups of audiences, suggesting similar audiences and computing a matching grade by identifying the strongest common category between the audiences.

The matching algorithm uses the multiple connections having different characteristics between each two nodes in the graph, where each node defines a “word” in our dictionary. Although some of the analyses may be quite simple and intuitive (e.g. the campaign looks for mobile developers and the event is directed at iOS developers), many analyses are expected to be more complex. For example, an advertiser may offer a security related product which may surprisingly be relevant for an event with multiple IT managers and other decision makers in organizations, who may be interested in the product. Another example, an advertiser may define his target audience as women who care more for the product's quality than for its cost. A matching event may be one to which most of the tickets were sold to women of a certain age group and having specific fields of interest which may lead to the assumption that they have a high income permitting them to make quality-based decisions.

The matching algorithms can also “understand” indirect connections. For example, if a connection of a certain strength has been defined between “mobile developers” and “Java developers” and another connection has been defined between “Java developers” and “.NET developers”, the algorithm can calculate the indirect connection between “mobile developers” and “.NET developers”.

The matching algorithm is also capable of inferring connections according to the context between groups. For example, an event having as participants technology managers (CTOs) who have evident connection to other top managers (CEOs) and also to technological people (e.g. IT managers). The context in which the CTO attends the event and his matching to the target audiences of the event are taken into consideration.

The matching algorithm uses supervised machine learning:
The connection between different nodes is weakened or strengthened according to measured de-facto results, which are measured by the campaign success in the event, the event organizer's decision to include the campaign in the event's digital folder and the place in which it had been placed.
New “words” added by the events crawler and their connections to other nodes (e.g. by appearing together with already analyzed nodes).

A pricing module 138 tries to predict the optimal bid-price to be offered by the advertiser in order to increase the probability of his advertisement being selected for the event by the ranking algorithm and the event organizer.

The pricing module simulates various scenarios by running the current adveriser's offer through previous events in which similar campaigns have offered certain prices, to determine the bid-price that will enhance the offer's chances of entering the event's digital folder over other offers and predict the number of leads the offer may receive.

The pricing algorithm takes into consideration a plurality of parameters, such as location of the event, dates, size, target audience etc. for comparison with previous relevant events.

A ranking module 160 combines the results of the matching module 135 and the pricing module 138 and ranks the various advertisers' offers accordingly. The ranking algorithm takes into consideration the matching extent of other offers in the digital folder and the bid for pay-per-action offered by the advertiser, in order to maximize the event organizer's monetization without affecting the productivity or relevancy of the digital folder.

An exemplary formula for calculating the offer's place in the digital folder may be:

Place=f1×matching result+f2×bid price+f3×other parameters

Where the coefficients (f1, f2, f3) may be determined by analyzing various scenarios and their potential impact on the digital folder, for example, too many similar offers or offers that require a certain action.

Other aspects to be considered are learned from previous events by analyzing the audiences' reactions to certain offers in certain types of events. Thus, the ranking algorithm also uses supervised machine learning to correct itself according to actual successes or failures.

The event organizer receives the ranking and decides which offers and in what order to store in the conference's digital folder 165, which will be displayed to the users (event participants) via computer software 175 (such as an application, a web interface etc.) before, during and after the event, using various distribution channels such as email, SMS etc. and on various electronic devices such as computer, tablet, smart phone, Google glasses, smart watch etc.

The user may decide whether to accept or reject the offer. According to embodiments of the invention the advertiser pays only for “accepted” offers, which enables him to measure his offer's success, the level of engagement and the effectiveness of his campaign vis-à-vis a specific target audience.

The system can analyze each event from the campaign's point of view, determine its relevancy and provide insights to each one of the players before, during and after the event.

When the event is over, the system calculates the number of offers accepted, debits the sponsor/advertiser accordingly and transfers part of the sum to the event organizer (as agreed in advance).

Both pricing and ranking algorithms run in real time, which means that the digital folder received by each participant may change during the event. For example, a small number of offers may be initially placed in the digital folder and other offers may be placed later, or offers may change place, according to various criteria such as the participant's opening the offers, their performance, optimal event organizer's budget consideration (e.g. a campaign that has not produced enough leads may be ranked lower than its original rank), temporarily increasing the ranking of “starved” offers to enable use of their budget, decreasing the ranking of offers nearing their budget etc.

An exemplary formula for calculating in real time an offer's rank may be:

Rank=k1*(1−((#Alloc−#Shown)*(LCR/Max_Leads−#Leads))+k2*(1−(#Alloc/#Attendees))+(k3*(bid/avg_bid)*LCR))+base_score

Where k1, k2, k3 are factors;

#Alloc is the number of times the offer has been allocated to a digital folder;

#Shown is the number of times the offer has been actually displayed;

LCR is the offer's conversion rate;

Max_Leads is the maximum number of leads the offer can produce (maximum budget);

#Leads is the actual number of leads produced by the offer;

#Attendees is the number of attendees that opened the digital folder;

Bid is the price-per-lead of the offer;

avg_bid is the average price-per-lead of the entire digital folder;

base_score is a minimum ranking for this offer (enables human intervention in cases where there is business logic in ranking an offer over others).

The number of real time calculations involved requires design consideration, e.g. advanced use of caching and nosql databases.

Offer Personalization

The system of the present invention provides personalization of offers provided to a participant during an event according to available information about the participant. This requires identifying the specific participant who has entered the digital folder and presenting him with relevant offers. For example, a development event may have hundreds of suitable offers; if a participant is known to have more specific fields of interest (e.g. IT development, phyton etc.) the system may place more relevant offers in his digital folder. This requires:
Identifying relevant fields of interest for each offer.
Allowing participants to Tag their fields of interest preferably when they register to the event, or when they open the digital folder.
Using the matching algorithm described above where the single participant or a group of participants are matched to the target audience defined by the event crawler.

The offer personalization uses the ranking algorithm to analyze offers in real time and change an offer's ranking not only for the general digital folder but also for each participant.

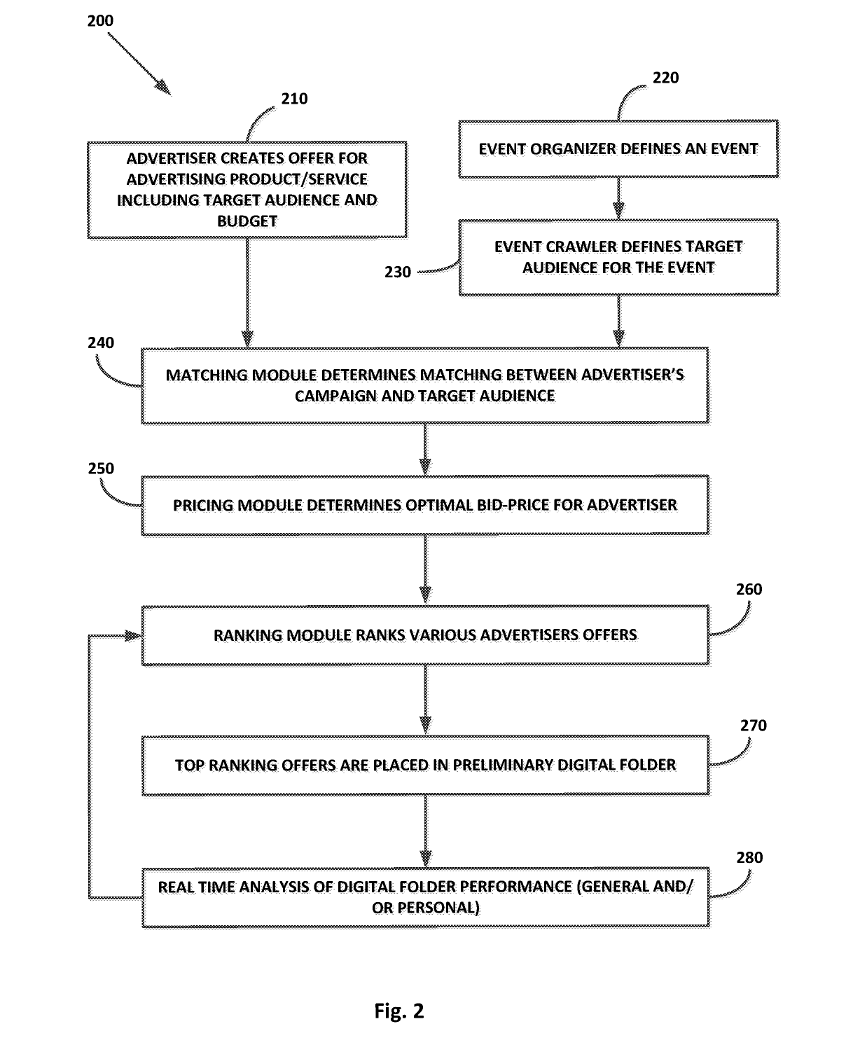

FIG. 2 is a flowchart 200 showing the various steps taken by the method according to embodiments of the present invention.

In step 210 the advertiser creates an offer for advertising a product or service, including product or service description, target audience and budget. The offer is communicated to the matching module.

In step 220, independent of step 210, an event organizer defines an upcoming event, including event name, place, date etc. The event definition is communicated to the matching module.

In step 230 the system's event crawler gathers online information regarding the event from various sources, “understands” the relevant fields of interest and defines a target audience for the event.

In step 240, the system's matching module determines matching between the advertiser's campaign and the target audience defined by the event crawler.

In step 250 the system's pricing module determines an optimal bid-price for the advertiser, by simulating various scenarios, e.g. running the current advertiser's offer through previous events in which similar campaigns have offered certain prices.

In step 260 the system's ranking module ranks the various advertisers' offers by combining the results of the matching module and the pricing module.

In step 270 the top ranking offers are placed in an initial digital folder to be offered to the event's participants.

In step 280 an ongoing analysis of the current digital folder's content is carried on in terms of performance, both generally and personally, which is fed back to the ranking module for continuous updating of the digital folders.

1. A computerized system for digital advertisement in live events, comprising:
a plurality of first computers configured to create advertisement campaign offers;
at least one second computer configured to define an event comprising a list of participants;
a matching engine communicating bi-directionally with said plurality of first computers and with said at least one second computer, said matching engine configured to rank advertisements for said event and create a digital folder of advertisements accordingly; and
a plurality of user electronic communication devices comprising a computer software configured to display said digital folder to said participants and enable interaction with said advertisements before, during or after said event;
said matching engine further comprising a campaign analytics module configured to personally update said ranking in real time according to each participant's interaction with said advertisements in said digital folder;
said computer software configured to display to each participant his personally ranked digital folder.

2. The computerized system of claim 1, wherein said matching engine further comprises:
a pricing module configured to predict optimal bid-prices to be offered by said advertisers; and
a matching module configured to determine the extent to which an event's target audience matches the advertiser's campaign; and
wherein said matching module is configured to rank said advertisements by combining the results of said matching module and the pricing module.

3. The system of claim 1, wherein each one of said advertisement campaign offers comprises description of a product or service to be advertised, target audience and budget.

4. The system of claim 1, wherein said event definition comprises event name, place and date.

5. A method of digital advertisement in live events, comprising:
creating a plurality of advertisement campaign offers, each advertisement campaign offer including a first target audience;
defining at least one event;
using online information for defining a second target audience for said at least one event;
matching said first and second target audiences for each one of said plurality of advertisements;
determining optimal bid-price for each one of said plurality of advertisements;
using said matching and said determined bid-price to rank said plurality of advertisements for said at least one event;
creating a digital folder for said at least one event, said digital folder comprising top ranking advertisement from said ranking process;
displaying said digital folder to participants of said at least one event;
receiving feedback of said participants' interactions with said advertisements in said digital folder before, during or after said event;
analyzing said feedback of each participant's interaction with said advertisements in said digital folder;
personally updating said ranking in real time according to said analysis; and
displaying to each participant his personally ranked digital folder.

6. (canceled)

7. The method of claim 5, wherein each one of said advertisement campaign offers comprises description of a product or service to be advertised, target audience and budget.

8. The method of claim 5, wherein said event definition comprises event name, place and date.

9. The method of claim 5, wherein said matching comprises:
defining a weighted graph of fields of interest; and
finding on said graph nodes corresponding to both said first and said second target audiences.

10. The method of claim 9, further comprising determining a third target audience according to said found nodes and the weights between them.

11. (canceled)
